(19) United States
(12) Patent Application Publication
(10) Pub. No.: US 2024/0278131 A1
(43) Pub. Date: Aug. 22, 2024

(54) GAME DEVICE AND STORAGE MEDIUM

(71) Applicant: BANDAI CO., LTD., Tokyo (JP)

(72) Inventors: Daisuke SAKAMOTO, Tokyo (JP); Yuri OKAMOTO, Tokyo (JP); Erika YASUDA, Tokyo (JP); Asaki MURAKAMI, Tokyo (JP); Atsushi YASHIKI, Tokyo (JP)

(73) Assignee: BANDAI CO., LTD., Tokyo (JP)

(21) Appl. No.: 18/581,411

(22) Filed: Feb. 20, 2024

(30) Foreign Application Priority Data
Feb. 21, 2023 (JP) 2023-025501

(51) Int. Cl. A63F 13/58; A63F 13/335; A63F 13/825

(52) U.S. Cl. CPC A63F 13/58; A63F 13/825; A63F 13/335

(57) ABSTRACT

A game device for playing a game accompanied by display of a character includes: an operation input interface; a management circuit configured to manage a time; a setting circuit configured to set a state of the character; a communication interface configured to communicate with an external device; and a controller configured to control an operation of the communication interface. The setting circuit is configured to set the state of the character to a first state when a current time falls within a predetermined time zone, and the controller is configured to enable the communication interface to communicate with the external device on a condition that the current time falls within the predetermined time zone and the state of the character is the first state.

### CROSS-REFERENCE TO RELATED APPLICATIONS

This application is based on and claims priority under 35 USC 119 from Japanese Patent Application No. 2023-025501 filed on Feb. 21, 2023, the contents of which are incorporated herein by reference.

### TECHNICAL FIELD

The present disclosure relates to a game device and a storage medium, and in particular to an electronic game accompanied by display of characters.

### BACKGROUND

There is a system that transmits and receives information about characters developed in different devices and presents amusement elements such as marriage between characters (Japanese Patent Application Laid-Open Publication No. 2014-064944 (hereinafter, referred to as Patent Literature 1)).

There are various types of devices for playing games. Among them, battery-powered devices (portable terminals) are highly convenient, as they allow a user to play a game on the move or in user's spare time.

On the other hand, if information transmission and reception as described in Patent Literature 1 is frequently performed with such a portable terminal, power consumption increases, so the power stored in the battery decreases, and it is likely that the portable terminal may not operate optimally at the timing when a player plays the game.

The present disclosure is to provide a game device and a storage medium that cooperates with an external device while ensuring amusement.

### SUMMARY

One aspect of the present disclosure relates to a game device for playing a game accompanied by display of a character. The game device includes: an operation input interface; a management circuit configured to manage a time; a setting circuit configured to set a state of the character; a communication interface configured to communicate with an external device; and a controller configured to control an operation of the communication interface. The setting circuit is configured to set the state of the character to a first state when a current time falls within a predetermined time zone, and the controller is configured to enable the communication interface to communicate with the external device on a condition that the current time falls within the predetermined time zone and the state of the character is the first state.

### BRIEF DESCRIPTION OF DRAWINGS

Exemplary embodiments of the present disclosure will be described in detail based on the following figures, wherein:

FIG. 1 is a diagram showing an example of a configuration of a game system according to an embodiment and a modified example of the present disclosure;

FIG. 2 is a diagram showing an example of a hardware configuration of a game device 100 according to the embodiment and modified example of the present disclosure;

FIG. 3 is a diagram showing an example of a hardware configuration of a server 200 according to the embodiment and modified example of the present disclosure;

FIG. 4 is a diagram for illustrating an interaction game according to the embodiment and modified example of the present disclosure;

FIG. 5 is a flow chart showing an example of update processing that is executed on a game device 100 according to a first embodiment of the present disclosure;

FIG. 6A is a diagram showing an example of a data structure of various types of information that is used in the game system according to the embodiment and modified example of the present disclosure;

FIG. 6B is a diagram showing an example of a data structure of various types of information that is used in the game system according to the embodiment and modified example of the present disclosure;

FIG. 6C is a diagram showing an example of a data structure of various types of information that is used in the game system according to the embodiment and modified example of the present disclosure;

FIG. 6D is a diagram showing an example of a data structure of various types of information that is used in the game system according to the embodiment and modified example of the present disclosure; and

FIG. 7 is another diagram for illustrating an interaction game according to the embodiment and modified example of the present disclosure.

### DESCRIPTION OF EMBODIMENTS

### First Embodiment

Hereinafter, embodiments will be described in detail with reference to the accompanying drawings. Note that the following embodiments do not limit the disclosure of the claims and all combinations of features described in the embodiments are essential to the disclosure.

Two or more of the features described in the embodiments may be arbitrarily combined. In addition, the same reference number is assigned to the same or similar component, and duplicate descriptions will be omitted.

An embodiment described below describes an example in which the present disclosure is applied to a game device that can play a game (hereinafter, referred to as a development game) in which characters are developed, which is an example of the game device. However, the present disclosure is applicable to any device having a communication function and configured to be able to play a game in which characters are displayed.

### Configuration of Game System

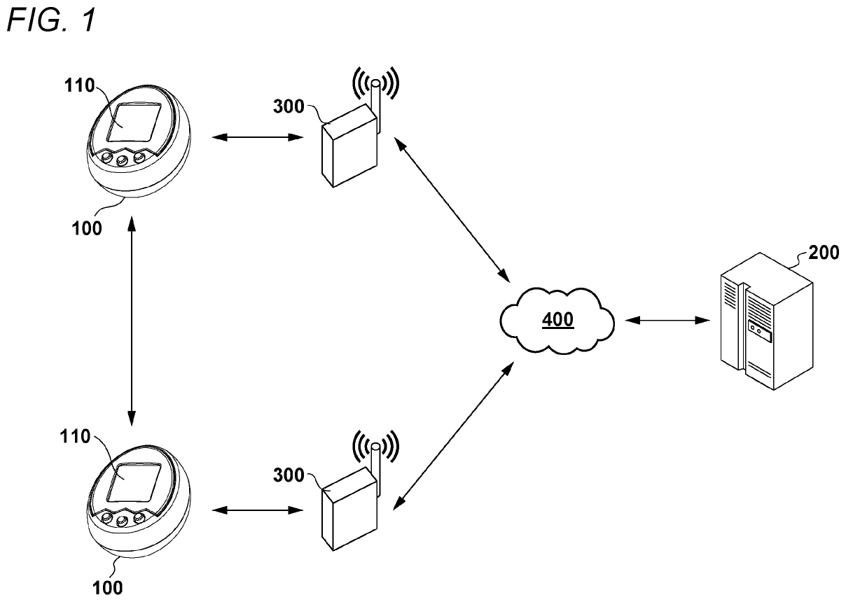

FIG. 1 is a diagram showing a configuration of a game system according to an embodiment of the present disclosure. As shown, in the game system, a game device 100 is configured to enable wireless communication with another game device 100 and a server 200. As will be described in detail below, the game device 100 is configured to enable communication by two types of communication methods and transmits and receives information using different communication methods when communicating with another game device 100 and when communicating with the server 200. As shown, communication between the game device 100 and the server 200 is performed via an access point (AP) 300 and a network 400, and thus is different from communication that is directly performed between the game devices 100. In the present embodiment, in order to realize interaction among users present in various areas, the network 400 is described as a wide area network (WAN) such as the Internet, but may also be a LAN in other aspects.

In the present embodiment, the game device 100 is configured in the form of a portable toy and operates using power supplied from a battery (not shown). For this reason, information between the game device 100 and the server 200 via the AP 300 is transmitted and received through wireless communication. It is assumed that the game device 100 is provided with a terminal (not shown) connectable to a power supply and is able to charge the battery by electrically connecting a commercial power supply or the like to the terminal via a power feeding cable.

### Hardware Configuration of Game Device

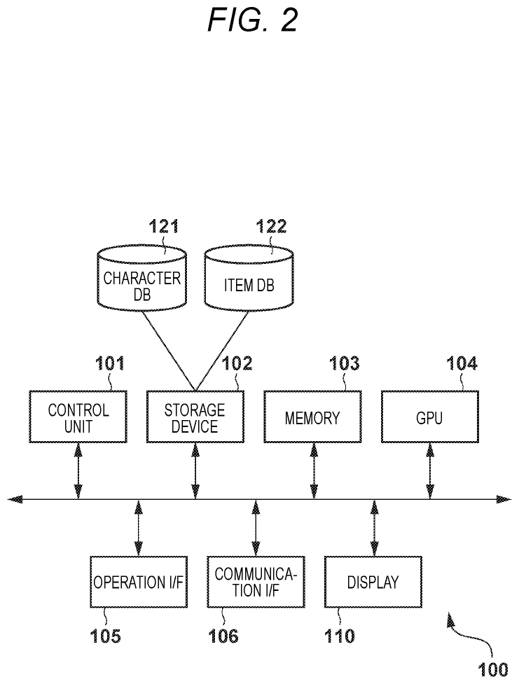

Subsequently, a hardware configuration of the game device 100 will be described using FIG. 2. FIG. 2 is a block diagram showing an example of a hardware configuration of the gate device 100.

A control unit 101 is a processor such as a CPU, and performs various controls including operation control of each hardware included in the game device 100. Specifically, the control unit 101, for example, reads out a necessary program stored in a storage device 102, deploys the program on a memory 103, and executes the program, thereby performing corresponding control. In addition, the control unit 101 has a built-in clock and is able to obtain the current time.

The storage device 102 is a device that can permanently store information, such as a non-volatile memory. The storage device 102 stores information on parameters necessary for implementing various controls, in addition to programs related to operations of the game device 100 and programs for a development game that is played on the game device 100. In addition, the storage device 102 also functions as a database (character DB 121 and item DB 122) of various data related to the development game. Additionally, the memory 103 is a storage device that is used to temporarily store data, such as a volatile memory. The memory 103 may be used not only as a deployment region for each program but also as a storage region for temporarily storing data and the like output during various hardware operations or various control processes.

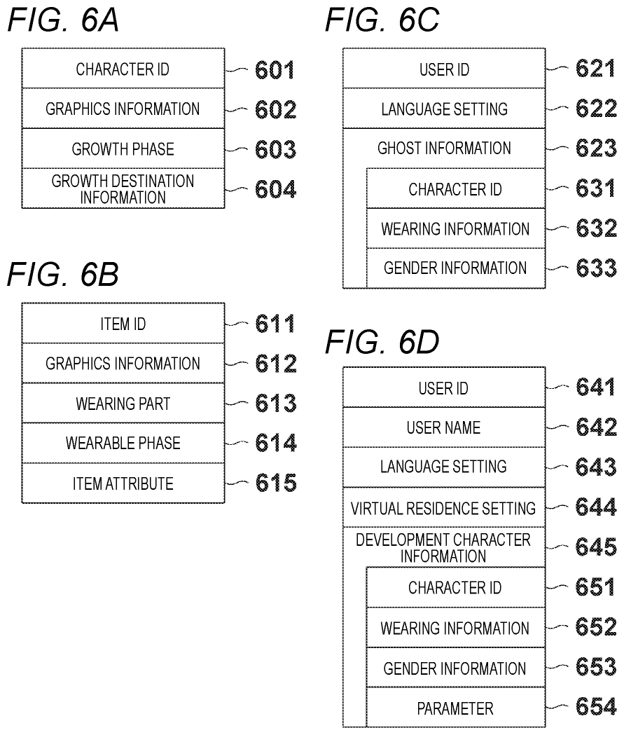

A character DB 121 is a database that manages, as records, information (character information) about characters that can be developed in the development game. In the development game that is played on the game device 100 of the present embodiment, a user can develop a character that grows through a plurality of growth phases. A character is configured so that an appearance thereof is different each time the growth phase changes. The character DB 121 manages, as records, various information about each appearance that a character can have at each growth phase. As shown in FIG. 6A, for example, the character information regarding one record includes, in association with a character ID 601 that uniquely identifies (appearance of) a character, graphics information 602 for rendering the appearance of the character, a growth phase 603 indicating a growth phase at which the character has the appearance, and growth destination information 604 indicating an appearance to which the character can grow from that appearance. The growth destination information 604 may be one in which information on the corresponding character ID 601 is stored.

In addition, an item DB 122 is a database that manages, as records, information (item information) about items that can be worn on characters in the development game. In the development game that is played on the game device 100 of the present embodiment, items can be worn on a character being developed. The item may be, for example, one that can be acquired in the development game, or may be one that can be obtained in the form of DLC (Downloadable Content) or the like by purchasing a predetermined product. As described above, the character changes in appearance at each growth phase, and the number of items that can be worn increases as the growth phase progresses. As shown in FIG. 6B, for example, the item information regarding one record of the item DB 122 includes, in association with an item ID 611 that uniquely identifies an item, graphics information 612 for rendering an appearance of the item, a wearing part 613 indicating a part of the character on which the item can be worn, a wearable phase 614 indicating a growth phase at which the item can be worn, and an item attribute 615 indicating an attribute annexed to the item.

The GPU 104 is a rendering device that performs various rendering processing related to creation of a display screen regarding the game device 100. The GPU 104 includes a GPU memory (not shown), develops various graphics data read from the storage device 102, and performs predetermined calculations, thereby creating various images (screens) related to the development game. The screen or image created by the GPU 104 is presented to the user, for example, by being displayed on a display 110 of the game device 100. The display 110 is a device that displays information provided by the game device 100, such as a liquid crystal monitor.

An operation I/F 105 is a user interface that receives an operation input provided by the game device 100. When the operation I/F 105 detects that an operation input has been made, the operation I/F outputs a control signal corresponding to the operation input to the control unit 101. In an aspect, the operation I/F 105 includes, for example, operation members such as buttons provided on the exterior of the game device 100 and various sensors. In addition, in an aspect in which the display 110 is able to detect a touch input, the operation I/F 105 includes a touch input detection sensor provided in the display 110.

A communication I/F 106 is a communication interface with an external device provided by the game device 100. As described above, the game device 100 of the present embodiment performs wireless information communication with other devices by two types of communication methods. One communication method is communication in an ad hoc mode (hereinafter, referred to as ad hoc communication) as the first communication method according to the present disclosure in which the game device 100 is not required to be connected to the AP 300 and information is directly transmitted and received between the devices in such a form that one of the game device 100 and another game device 100 becomes a host and the other connects to the host. Another communication method is communication in an infrastructure mode (hereinafter, referred to as infrastructure communication) as the second communication method according to the present disclosure in which each game device 100 connects to the associated AP 300 and information is transmitted and received between the game device 100 and the server 200 via the AP 300 and the network 400. Note that in the present embodiment, the two types of communication methods that the communication I/F 106 can use are described as the ad hoc communication and the infrastructure communication. However, the implementation of the present disclosure is not limited thereto, and other types of communication can also be included.

### Hardware Configuration of Server

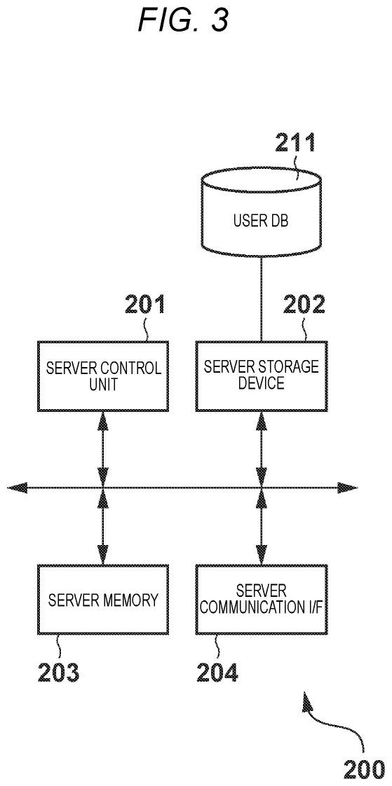

FIG. 3 is a block view showing a hardware configuration of the server 200 according to the present embodiment. Note that in the following description, the hardware configuration that realizes functions, which are the same as, and/or similar to, those of the game device 100, will be prefixed with the letter “server” in order to distinguish the same from the configuration of the game device 100.

A server control unit 201 is a processor such as a CPU, and performs operation control of each hardware included in the server 200 and control regarding realization of various functions including user management and an interaction function regarding the development game. Specifically, the server control unit 201, for example, reads out a necessary program stored in a server storage device 202, deploys the program on a server memory 203, and executes the program, thereby performing corresponding control.

The server storage device 202 is a device that can permanently store information, such as a non-volatile memory or an HDD. The server storage device 202 stores, in addition to an operating system for operating the server 200 and a matching program, information on parameters and various data necessary for implementing various controls. In addition, the server storage device 202 also functions as a database of various data regarding users who use the game devices 100. Additionally, the server memory 203 is a storage device that is used to temporarily store data, such as a volatile memory. The server memory 203 may be used not only as a deployment region for each program but also as a storage region for temporarily storing data and the like output during various hardware operations or various control processes.

A user DB 211 is a database that manages, as records, information (user information) about users who use the game devices 100. In the game system of the present embodiment, a progress status of the development game of the game device 100 used by each user is managed on the server 200 and is configured to be shareable with another game device 100, in order to provide elements for characters to interact with each other even when the game devices 100 are not directly connected to each other. For example, as shown in FIG. 6C, the user information regarding one record of the user DB 211 includes, in association with a user ID 621 that uniquely identifies a user, a language setting 622 set in the game device 100 used by the user, and ghost information 623 about a character that the user is developing on the game device 100. Here, for the user ID 621, unique information such as an individual identification number of the game device 100 used by the user may be used.

In addition, the information about the character being developed on each game device 100, which is managed in the user DB 211, indicates a status of the character being developed on the game device 100 at the time of receiving the information, and strictly speaking, may be different from the character being developed on the game device 100 at the time when the information is used in the server 200 and the like. For this reason, in the present embodiment, the information about the character managed in the user DB 211 is expressed as “ghost” in order to mean an appearance of the character that was being developed at a certain point in time, and is managed as the ghost information 623. The ghost information 623 may include a character ID 631 indicating an appearance of the character being developed, wearing information 632 indicating an item wearing status on the character, and gender information 633 indicating the gender of the character.

A server communication I/F 204 is a communication interface with an external device provided by the server 200. Information communication between the server communication I/F 204 and an external device may be performed via a wide area network (WAN) such as the Internet, or may be performed via a LAN or the like. The information communication performed by the server communication I/F 204 may be performed in a wired manner or a wireless manner.

### Game Outline

Below, an outline of a game in which play experience is provided on the game device 100 of the present embodiment will be described. In the present embodiment, the game is described as a development game that provides, as amusement elements, a development element of a character, a communication element between a user and a character, and an interaction element between characters. However, the development game is only one type of game in which a character appears, and the implementation of the present disclosure is not limited thereto. The present disclosure is applicable to any game in which a character whose motion is controlled in response to an operation input made by the user appears. Here, the motion control is not limited to directly operating a character by the user, but includes indirectly changing behavior or motion of a character in response to changes in parameters or environment as a result of evaluating the operation input made by the user.

In the development game, a user can develop a character by performing an operation input regarding the care of the character. The development game starts with, for example, hatching an egg, progresses through growth phases by sequentially making operation inputs regarding necessary care, and presents growing aspects of the character while changing an appearance of the character.

The character is configured so that an item can be worn, and the user can add decoration to the appearance of the character by wearing an item and the like acquired in the development game on the character. Parts where items can be worn are configured to increase as the growth phase progresses, and the parts where items can be worn are limited to certain portions until a predetermined growth phase is reached. The wearable parts may include, for example, the character's head, face, torso, legs, and hands, and may be configured so that a hat item, a glasses item, a clothing item, a shoe item, an accessory (belongings), and the like can be worn, respectively.

The operation input regarding a character is not limited to directly controlling the character, such as an operation input regarding such a care or selection of an item to be worn, and may also include, for example, generating controls that indirectly affect the character, such as deciding on an item to be placed in a residence space of the character or selecting a gift to give.

In addition, in the development game of the present embodiment, in order to allow the user to perceive the character as a living creature, the character, the behavior, and the like are configured to change not only according to the growth stage or state transition but also according to a time zone. For example, a character is controlled to perform waking-up behaviors, including yawning in the living room, from 7:00 a.m. (wake-up time) to 7:14 a.m., and to perform morning preparation behaviors, including brushing teeth in the bathroom, from 7:15 to 7:29 a.m. In addition, for example, the character is controlled to behave in the living room as if the character were hungry and urging a snack, from 15:00 to 15:29. Additionally, the character is controlled to perform sleepy behaviors, including yawning in the living room, from 30 minutes before the preset bedtime (e.g. 21:00) to the bedtime, and to move to the bedroom, to prepare for sleep and to perform sleeping behaviors from the bedtime to 6:59 a.m. the next morning.

The character's behaviors according to the time zones are also effective in controlling the life rhythm of users, such as children, or providing knowledge about raising living things. Additionally, the character in the sleeping state is controlled to such a state that it does not accept any operation input regarding the character that was accepted in other states. That is, the character in the sleeping state is controlled so that, even if an operation input regarding the character is made, various controls regarding the character are not performed in response to the operation input. By doing so, it is possible to prevent a user from playing excessively the development game. Also, it is possible to reduce excessive consumption of power from the battery.

### Communication Element

The development game is configured so that a character developed by another user can be caused to appear through communication with an external device. For this reason, the game device 100 obtains information about the character being developed by another user via the communication I/F 106. As described above, the communication I/F 106 enables information communication by two types of communication methods, each of which can obtain information about characters. More specifically, the communication I/F 106 obtains information about the character being developed on another game device 100 via the ad hoc communication from another game device 100. Additionally, the communication I/F 106 obtains information about the character being developed on any one game device 100 that has been connected to the server 200 via the infrastructure communication from the server 200.

In the below, the character being developed on the game device 100 is referred to as an “own character”. The character being developed on another game device 100, the information thereof being obtained via the ad hoc communication from another game device 100, is referred to as a “friend character”. The character being developed on any one game device 100 connected to the server 200, the information thereof being obtained via the infrastructure communication from the server 200, is referred to as an “another-user character” in order to make a distinction. In other words, the own character is, in the development game played on the game device 100, a character whose motion is controlled in response to an operation input of a user of the game device 100. In addition, the friend character is, in the development game played on another game device 100 connected via the ad hoc communication, a character whose motion is controlled in response to an operation input of a user of the game device 100. Additionally, another-user character is, in the development game played on any one game device 100 communication-connected to the server 200, a character whose motion is controlled in response to an operation input of a user of the game device 100.

In order to enable obtainment of information about a character via the infrastructure communication, each game device 100 is configured to periodically connect to the server 200 via the infrastructure communication, for example, at a predetermined time, and to upload information about an own character being developed. The uploaded information about the own character is used to update the ghost information 623 of the user information managed for the corresponding user. Accordingly, the game device 100 is configured to regularly upload the user ID, the language setting, and the information about the own character (character ID, wearing information, gender information) to the server 200, as well as the user information.

These pieces of information are structured by obtaining necessary information from owner information managed for the user in the game device 100. For example, as shown in FIG. 6D, the owner information includes, in association with a user ID 641 that uniquely identifies a user, a user name 642 indicating a nickname of the user set by the user, a language setting 643 indicating a display language set in the game device 100, a virtual residence setting 644 indicating an in-game residence of the own character, and development character information 645 indicating information about the own character, and may be maintained in the storage device 102. The development character information 645 includes a character ID 651 indicating an appearance of the own character, wearing information 652 indicating an item worn on the own character, gender information 653 indicating the gender of the own character, and a parameter 654 of the own character that can change depending on a development status.

Additionally, when uploading the information about the own character, each game device 100 obtains information about another-user character from the server 200 in order to use the same in an interaction game described below. When the server 200 receives the information about the own character from each game device 100, the server randomly selects a predetermined number (for example, a predetermined number of 10 or greater) of user information from the user information managed in the user DB 211 for users other than the user of the game device 100. Then, the server 200 transmits the language setting 622 and the ghost information 623 of the selected predetermined number of user information to the game device 100 as information about another-user character.

When the predetermined number of pieces of information about another-user character is received via the infrastructure communication, the control unit 101 registers the information in an another-user list as the second list according to the present disclosure. Here, the another-user list is a list that manages information for displaying another-user character in an interaction game and is maintained in the storage device 102, for example.

In contrast, the information about the friend character is obtained from another game device 100 on the condition that the user has made in the game device 100 an operation input to communicate with another game device 100. In addition, at this time, the game device 100 similarly transmits the information about the own character to another game device 100 that is a communication partner.

Since a user whose ghost information is shared via the infrastructure communication cannot be determined to be an acquaintance or friend of the user who is developing a character related to the ghost information, it is not preferable to share information such as a nickname that leads to identification of the user. For this reason, as described above, the information about another-user character transmitted from the server 200 does not include information (user ID 641, user name 642) leading to identification of an individual user. On the other hand, in the ad hoc communication, information is basically transmitted and received directly in a state in which the game devices 100 are put into a state of enabling communication at the same time. Therefore, it is assumed that the user of the game device 100 and the user of another game device 100 are acquaintances or friends. For this reason, the information about a character (information about the friend character/information about the own character) transmitted and received between the game devices 100 via the ad hoc communication is structured differently from the information about another-user character obtained by each game device 100 via the infrastructure communication. That is, in order to provide amusement elements that can be enjoyed between acquaintances or friends, information that is transmitted and received via the ad hoc communication includes information such as a nickname of the user. More specifically, the information about a character transmitted and received via the ad hoc communication includes, for example, the user ID 641, user name 642, game device language setting 643, virtual residence setting 644, and development character information 645 of the owner information managed in each game device 100.

When the information about a friend character is received via the ad hoc communication, the control unit 101 registers the same along with information on a reception date and time in a friends list as the first list according to the present disclosure. Here, the friends list is a list that manages information for displaying a friend character in an interaction game and is maintained in the storage device 102, for example.

In addition, the friends list and the another-user list have different list update conditions. In the present embodiment, the friends list is configured to be able to manage information about friend characters regarding up to eight users who have communicated via the ad hoc communication. When the information about a friend character is received via the ad hoc communication, the control unit 101 determines whether information about the same friend character has been already registered in the friends list. The above determination can be made, for example, by checking whether information with the same user ID has been registered in the friends list based on the user ID included in the received information. When information about the same friend character has been already registered, the control unit 101 updates the information about the same friend character registered in the friends list with the newly received information. This allows a user who has previously performed ad hoc communication to update the information of the character being developed (friend character) to the latest state. Additionally, when information about the same friend character has not been registered, the control unit 101 additionally registers the newly received information in the friends list. At this time, if information about up to eight friend characters has been already registered in the friends list, the control unit 101 replaces the oldest information registered in the friends list with the newly received information, thereby registering the newly received information in the list.

On the other hand, the another-user list is configured to be able to manage information about the predetermined number of another-user characters received from the server 200. When the control unit 101 receives the information about the predetermined number of another-user characters via the infrastructure communication, the control unit replaces all information currently registered in the another-user list with the information, thereby registering the information in the another-user list. That is, in the game device 100 of the present embodiment, all information in the another-user list is updated every time infrastructure communication is performed. The reason is described: unlike the friend character, the another-user character is not a character related to an acquaintance, a friend, and the like, so the another-user character does not need to be maintained for a long period of time, and the another-user character is updated frequently, thereby providing the user with such an amusement element that a game is being played with many users.

Additionally, the another-user list is referred to when an interaction game described below is played, and the information is used in order to cause an another-user character to be displayed in the interaction game. In other words, the information registered in the another-user list does not need to be updated when the interaction game is not played. Therefore, in an aspect, in order to reduce an amount of information transmitted and received via the infrastructure communication and to reduce an amount of power consumed in connection with communication, obtainment of the information about an another-user character from the server 200 may be performed on the condition that the another-user character is displayed in the interaction game based on the information registered in the another-user list. The above control may also be realized by not making a request to transmit information about an another-user character from the game device 100.

### Interaction Game

The development game of the present embodiment can continuously develop a character of one body, but includes an element that allows development of a new-generation character created by, for example, marrying another character. Due to the above element, it is possible to maintain a high level of interest in the development game without making a user bored.

When the ad hoc communication is performed, the game device 100 of the present embodiment can play a communication game of showing an aspect in which a friend character being developed on the communication partner's game device 100 is displayed and interacts with an own character. Accordingly, by using the above communication game to marry the own character and the friend character, it is possible to open up a development element of a new-generation character. On the other hand, the amusement element related to such a communication game requires that the owner of another game device 100, which is a communication partner, be present nearby. In addition, if the character to be married is limited to a character developed by a close acquaintance or friend, there is a possibility that a type of a character that can be created will be limited.

For this reason, the game device 100 of the present embodiment has an interaction game playing function in order to provide elements of interaction with various characters, including marriage with another character. The interaction game is structured so that characters (friend character, another-user character) whose information is registered in advance in the maintained friends list and another-user list are caused to appear in order to allow play even in an offline situation. In addition, in order to provide amusement by displaying characters with various personalities (characters decorated with various items) and amusement related to the marriage, it is assumed that the friend character and another-user character displayed in the interaction game are limited to characters who have reached a predetermined growth phase. Similarly, the interaction game is structured to be playable on the condition that the own character has reached the predetermined growth phase.

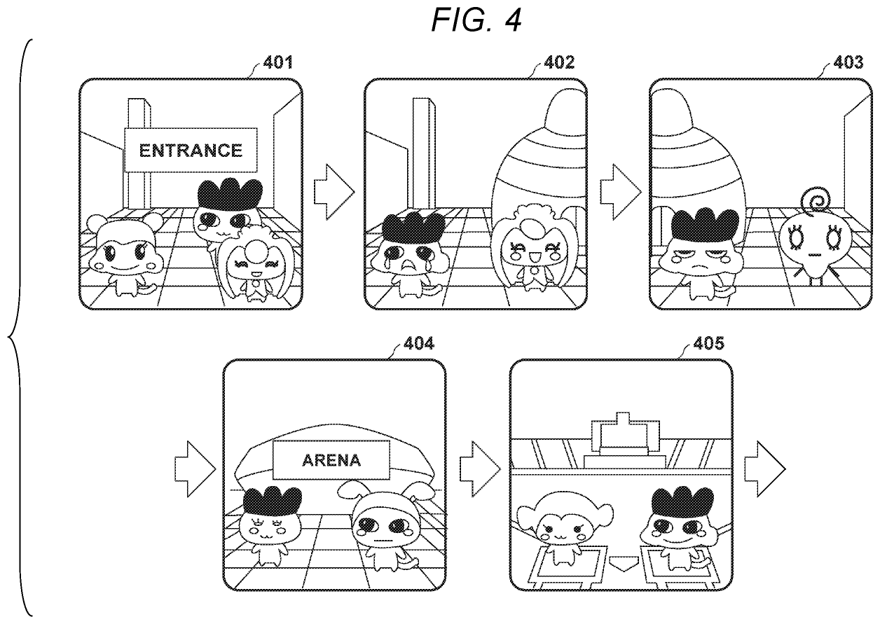

The interaction game is developed using an interaction area as shown in FIG. 4. As shown, in the present embodiment, the interaction area is composed of five regions, and when an operation input related to area movement is made, different regions are displayed sequentially (region 401→region 402→region 403→region 404→region 405→region 401→ . . . ). In a predetermined area, characters selected from friend characters whose information is registered in the friends list and another-user characters whose information is registered in the another-user list are placed separately in each region. The selected characters are placed in one certain region and are configured to be able to interact with the own character in the region.

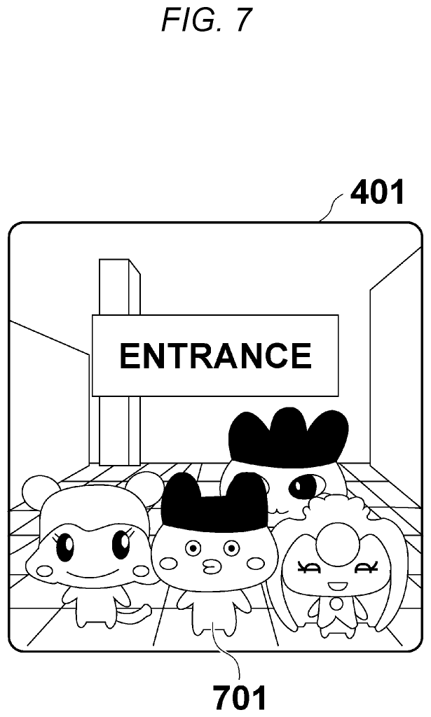

At the start of the interaction game, for example, after displaying the entire region, a performance showing the own character moving to the interaction area is displayed. An entrance gate of the interaction area is provided in one region 401 among the five regions, and the region 401 is controlled to be displayed at the start of the interaction game. As shown in FIG. 7, an own character 701 is displayed in the region 401 together with friend character or another-user character first placed in the region. When the user wants to move the own character 701 to another region, the user can move and display the own character 701 to the next region in the display order (the region 402 after the region 401) by making an operation input regarding region movement.

In the interaction area, motion of the friend character or another-user character placed is controlled without depending on the operation input of the user using the game device 100. In the interaction game of the present embodiment, the motion performed by the friend character or another-user character placed in the interaction area includes motion accompanied by a greeting performance to the own character. In order to convey to the user the amusement of interaction with users from various countries, the greeting performance is displayed differently based on the information of the language setting associated with the friend character or another-user character. For example, for an another-user character associated with a language setting of English, a greeting performance including a speech balloon display saying “Hi!” is displayed, and for an another-user character associated with a language setting of French, a greeting performance including a speech balloon display saying “Salut!” is displayed.

### Selection Control of Displayed Characters

The number of characters placed in the interaction area is determined in advance, and in the present embodiment, one character is placed as a friend character and 10 characters are placed as another-user characters. Therefore, when playing an interaction game, the control unit 101, for example, selects one piece of information by lottery from the information registered in the friends list, and places one friend character corresponding to the information in a predetermined area. Additionally, when playing an interaction game, the control unit 101, for example, selects 10 pieces of information by lottery from the information registered in the another-user list, and places 10 another-user characters corresponding to the information in a predetermined area.

### Automatic Update

In order to improve the amusement of the interaction game that enables interaction with various characters in this way, it is preferable to update the user information managed for each user by the server 200 and to provide information about the character of the updated content to each game device 100. For this reason, in the game system of the present embodiment, the infrastructure communication between the game device 100 and the server 200 is configured so that it is performed without requiring an operation input regarding a communication start request from the user. That is, the game device 100 has an “automatic update” function of transmitting and receiving information with respect to the server 200 through the infrastructure communication when a specific condition is fulfilled, even without an operation input by a user.

In the game device 100 of the present embodiment, the game device 100 using the automatic update function and the server 200 are basically configured to communicate information at a frequency of once a day. More specifically, the game device 100 is configured to perform automatic update on the condition that the game device 100 is in a predetermined time zone and the own character is in a sleeping state. The time zone predetermined for automatic update (hereinafter, referred to as ‘update time zone’) can be set so that it comes in a daily cycle, for example, from 21:00 every day to 6:59 a.m. the next morning. This is because a user is less likely to operate the game device 100 during the time zone and changes in various information are also less likely to occur. As described above, when the own character is in a sleeping state, the game device 100 is controlled so as not to accept an operation input regarding the own character. Therefore, when the game device is configured to perform the automatic update using the corresponding timing, it is possible to avoid a situation in which the latest information is not managed by the server 200 due to a change in the state or parameter of the own character caused by a user's operation input. In addition, when the game device 100 updates information or updates the main body based on information received from the server 200, it is possible to avoid a situation in which the operation input being performed by the user is interrupted and the update operation is not performed properly.

Here, it is assumed that the state (sleeping state) in which the own character is sleeping means, for example, that the current time has reached the bedtime set by the user and the setting to the sleeping state has been completed through a performance regarding preparation for bed or a performance regarding bed. That is, a case where the user can recognize a sleeping state from an image of the own character displayed on the display 110 and the game device 100 is put in a state in which an operation input regarding the own character is not accepted is managed as a state in which the own character is sleeping.

Therefore, if the own character is not yet in the sleeping state even when the update time zone has come, the control unit 101 does not execute the automatic update function and waits until the conditions for execution are fulfilled. In an example of the present embodiment, the control unit 101 waits for the execution of the automatic update function until the state of the own character completely transitions to the sleeping state.

When the automatic update function is executed, the control unit 101 controls the game device 100 to be in a communicable state with the server 200 via the communication I/F 106. Since communication between the game device 100 and the server 200 is performed through the infrastructure communication, it is assumed that the function is set up with information on the AP 300 to be communicated as a premise.

In the automatic update function, the following information is transmitted and received.

From the game device 100, the information about the game character is transmitted to the server 200. As described above, the information about the own character includes the user ID 641, language setting 643, and development character information 645 of the owner information managed in the game device 100. The information about the own character is transmitted for mainly updating the ghost information on the own character.

From the server 200, information about another-user characters that are candidates for display in the interaction game is transmitted to the game device 100. The information to be transmitted includes a predetermined number of pieces of ghost information selected by the server control unit 201 each time information is transmitted and received with respect to the game device 100. As described above, the information about another-user characters includes the language setting and ghost information on the user who has developed each another-user character.

In addition, update data for the firmware of the main body of the game device 100 is also transmitted from the server 200 to the game device 100. Some of function addition, bug fixing, and the like of the game device 100 are performed by updating the firmware of the main body. In addition to this, the function addition is also performed by transmitting additional content data (new event data or new download content (DLC) data) of the game content (development game) playing on the game device 100 from the server 200 to the game device 100 and changing data that is referenced during playing of the development game on the game device 100. Here, the new DLC data may include data for sale or data for rendering of newly added content. Therefore, these additional content data is also transmitted from the server 200 to the game device 100. Additionally, various new information from a game system operator side, such as notification information, which does not directly affect the processing of the development game, is also transmitted from the server 200 to the game device 100.

Therefore, according to the automatic update function, the game device 100 transmits information about the own character, receives update data for the main body of the game device 100, receives new information, receives additional content data, and receives information about a character corresponding to another game device, during communication connection with the server 200.

Note that not all of these information transmissions and receptions need to be performed during single communication connection for automatic update. For example, there is no need to update the ghost information about the own character if there is no change in appearance of the own character in the game device 100, so there is no need to transmit information about the own character. In addition, there is no need to receive the update data for the main body, the additional content data, and the new information if there is nothing to be transmitted to the server 200 side (no newly updated information exists) or if, even if there is, the game device 100 has already received the same. That is, in the automatic update function, at least one of the above-described information transmissions and receptions may be performed. By doing so, an amount of data communication performed by the game device 100 can be reduced and battery consumption can be suppressed.

### Update Processing

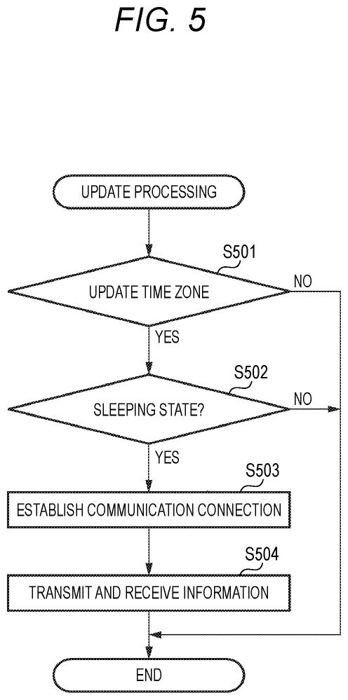

Below, specific processing will be described using a flow chart of FIG. 5 regarding update processing that is performed in relation to the automatic update function in the game device 100 of the present embodiment. The processing corresponding to the above flow chart can be implemented by the control unit 101, for example, reading a corresponding processing program stored in the storage device 102, deploying the program to the memory 103, and executing the program. Note that the update processing is described as being repeatedly executed at regular time intervals, for example, while the game device 100 is running.

In S501, the control unit 101 determines whether a current time falls within the update time zone. If it is determined that the current time falls within the update time zone, the control unit 101 moves the processing to S502, and if it is determined that the current time does not fall within the update time zone, the control unit completes the update processing.

In S502, the control unit 101 determines whether the own character is in a sleeping state. If it is determined that the own character is in the sleeping state, the control unit 101 moves the processing to S503, and if it is determined that the own character is not in the sleeping state, the control unit repeats the processing of this step until the own character is put in the sleeping state.

In S503, the control unit 101 controls the communication I/F 106 to be in a state where the infrastructure communication can be performed and establishes communication connection with the server 200.

In S504, the control unit 101 transmits and receives information regarding the automatic update function with respect to the server 200 and completes the update processing.

By doing so, according to the game device of the present embodiment, it is possible to cooperate with an external device while ensuring amusement.

### Modified Example 1

In the above-described embodiment, the transmission and reception of information regarding the automatic update function has been described as being performed on the condition that the own character is in the sleeping state. However, the implementation of the present disclosure is not limited thereto. For example, information may be transmitted and received when the own character is in a state other than the sleeping state, as long as there are no problems such as changes in the transmitted information or effects on the processing that is performed based on the received information.

### Modified Example 2

In the above-described embodiment and modified example, the update time zone has been described as coming in a daily cycle. However, the implementation of the present disclosure is not limited thereto. For example, the update time zone may be set so that it comes in an arbitrary time cycle.

### Modified Example 3

In the above-described embodiment, it has been explained that transmission and reception of information regarding the automatic update function can be performed each time the update time zone comes. However, the implementation of the present disclosure is not limited thereto. For example, when the power supply of the game device 100 is turned on at 6 a.m. and information has been transmitted and received, even if information is transmitted and received again later at 21 o'clock, there is a possibility that there is no change in the state of the own character and the information to be transmitted by the server 200. In this case, even if communication is performed, no significant information is transmitted and received, which consumes data communication traffic or battery power. Accordingly, the control unit 101 may control the information regarding the automatic update function to be transmitted and received on the condition that a predetermined time, such as 22 hours, has elapsed since the recent communication connection with the server 200.

### Second Embodiment

In the above-described embodiment and modified examples, the aspect in which the update processing is executed without considering the state of charge of the battery mounted on the game device 100 has been described. However, the implementation of the present disclosure is not limited thereto. For example, if the remaining power in the battery runs out during information transmission and reception and communication is thus terminated, it is also conceivable that the game device 100 may not operate normally because the firmware update was insufficient. Therefore, in the update processing, the control unit 101 may additionally detect the state of charge of the battery and control the information regarding the automatic update function to be transmitted and received on the condition that the power feeding cable is currently connected and charging. That is, in the present aspect, the control unit 101 establishes communication connection with the server 200 and controls the information regarding the automatic update function to be transmitted and received, on the condition that the current time falls within the update time zone, the own character is set to be in the sleeping state, and the game device 100 is under charging.

### Modified Example 4

In the above-described embodiments and modified examples, the game device 100 has been described as being in the form of a portable toy and connected to the server 200 through wireless communication. However, the implementation of the present disclosure is not limited thereto. The game device 100 does not need to be in the form of a portable toy, and the communication connection with the server 200 may also be made in a wired manner.

### Third Embodiment

In the above-described embodiments and modified examples, control is made so as not to accept an operation input by the user when the own character is in the sleeping state, so that information regarding the automatic update function is transmitted and received on the condition that the current time falls within the update time zone and the own character is in a sleeping state. However, the implementation of the present disclosure is not limited thereto.

The operation input performed on the game device 100 is not limited to the operation input regarding the own character, and may also include, for example, an operation input regarding the setting of the game device 100. That is, even if the own character is in the sleeping state and no operation input regarding the own character is accepted by the user, it cannot be concluded that the user is not performing any other operation input. For example, a normal operation may not be guaranteed when the firmware of the main body of the game device 100 has been updated.

For this reason, in an aspect in which the game device 100 is configured to transition to a suspended state (an operating state in which power consumption is suppressed while maintaining the stored contents of the memory 103) in response to no operation input for a predetermined period, the control unit 101 may control the information regarding the automatic update function to be transmitted and received on the condition that the game device 100 is in the suspended state. That is, in the present aspect, the control unit 101 establishes communication connection with the server 200 and controls the information regarding the automatic update function to be transmitted and received, on the condition that the current time falls within the update time zone, the own character is set to be in the sleeping state, and the game device 100 is in a suspended state.

Note that the suspended state may be released when, for example, the communication I/F 106 detects a certain operation input or when a condition for occurrence of a predetermined event is fulfilled in a development game.

### Modified Example 5

In the above-described embodiments and modified examples, the update processing has been described on the premise that communication connection between the game device 100 and the server 200 can be established. However, the implementation of the present disclosure is not limited thereto. That is, there is a possibility that the communication connection between the game device 100 and the server 200 may not be established due to a communication situation with the AP 300, a service provision situation of the server 200, a failure occurrence situation of the network 400, and the like. For this reason, the control unit 101 sets a time limit when establishing communication connection, and determines that a failure has occurred when the communication connection is not established within the time limit. When it is determined that establishment of the communication connection has failed, the control unit 101 retries the communication connection at a predetermined time interval. The retry is performed a predetermined number of times as an upper limit, such as three times in one update time period, for example. Additionally, the time interval for retry may be set to be longer, for example, 10 minutes→20 minutes→1 hour each time the number of times of retry increases so that retry is performed at a timing when improvement in the communication situation is expected.

### Summary of Embodiments

The above embodiment discloses at least the following game device and program.

(1) A game device configured to play a game accompanied by display of a character display, the game device including:
an operation input interface,
a management circuit configured to manage a time,
a setting circuit configured to set a state of the character,
a communication interface configured to communicate with an external device, and
a controller configured to control an operation of the communication interface,
wherein the setting circuit is configured to automatically set the state of the character to a first state when a current time falls within a predetermined time zone, and
wherein the controller is configured to enable the communication interface to automatically communicate with the external device on a condition that the current time falls within the predetermined time zone and the state of the character is the first state.

(2) The game device according to (1), wherein the predetermined time zone is configured to come in a daily cycle.

(3) The game device according to (1) or (2), wherein the controller is further configured to enable the communication interface to communicate with the external device on a condition that a predetermined time has elapsed since a recent communication with the external device by the communication interface.

(4) The game device according to any one of (1) to (3), wherein the first state is a state in which the game does not accept no operation input regarding the character.

(5) The game device according to (4), wherein the game is such a game that control regarding the character is performed in response to an operation input regarding the character, when the state of the character is a second state different from the first state.

(6) The game device according to any one of (1) to (5), wherein the communication interface is configured to perform communication wirelessly, and
wherein the controller is further configured to cause the communication interface to communicate with the external device, on the condition that information on an access point of the communication interface is set.

(7) The game device according to any one of (1) to (6), wherein the game device is configured to operate with power supplied from a battery,
wherein the game device further includes a detector configured to detect a state of charge of the battery, and
wherein the controller is further configured to enable the communication interface to communicate with the external device on the condition that the battery is being charged.

(8) The game device according to any one of (1) to (7), further including:
a transition circuit configured to transition the game device to a suspended state in response to no operation input for a predetermined period of time, and
a return circuit configured to return the game device from the suspended state in response to an operation input being made or occurrence of a predetermined event,
wherein the controller is further configured to enable the communication interface to communicate with the external device on a condition that the game device is in the suspended state.

(9) The game device according to any one of (1) to (8), wherein when the current time falls within the predetermined time zone but another condition for enabling the communication interface to communicate with the external device is not fulfilled, the controller waits until the another condition is fulfilled.

(10) The game device according to any one of (1) to (9), wherein when the communication interface fails to establish communication connection with the external device, the controller causes the communication interface to retry the communication connection up to a predetermined number of times at a time interval.

(11) The game device according to (10), wherein the time interval is set to be longer each time the number of times of retry increases.

(12) The game device according to any one of (1) to (11), wherein the communication interface is configured to perform at least one of transmission of information about the character, receipt of update data for a main body of the game device, receipt of new information, receipt of additional content data, and receipt of information about a character corresponding to another game device, during communication connection with the external device.

(13) The game device according to (12), wherein the information about the character includes at least one of information indicating an appearance of the character.

(14) The game device according to (13), wherein the communication interface is configured to transmit the information about the character on a condition that a change has occurred in the appearance of the character in the game.

(15) The game device according to any one of (12) to (14), wherein when there is an update in the update data for the main body, the new information, and the additional content data, the communication interface receives the updated data or information.

(16) A non-transitory computer-readable storage medium storing a program for causing a computer to function as the game device according to any one of (1) to (15).

### Other Embodiments

The disclosure is not limited to the above-described embodiments, and various modifications and changes can be made within the scope of the gist of the disclosure.

1. A game device for playing a game accompanied by display of a character, the game device comprising:
an operation input interface;
a management circuit configured to manage a time;
a setting circuit configured to set a state of the character;
a communication interface configured to communicate with an external device; and
a controller configured to control an operation of the communication interface,
wherein the setting circuit is configured to set the state of the character to a first state when a current time falls within a predetermined time zone, and
wherein the controller is configured to enable the communication interface to communicate with the external device on a condition that the current time falls within the predetermined time zone and the state of the character is the first state.

2. The game device according to claim 1, wherein the predetermined time zone is configured to come in a daily cycle.

3. The game device according to claim 1, wherein the controller is further configured to enable the communication interface to communicate with the external device on a condition that a predetermined time has elapsed since a recent communication with the external device by the communication interface.

4. The game device according to claim 1, wherein the first state is a state in which the game does not accept no operation input regarding the character.

5. The game device according to claim 4, wherein the game is a game that control regarding the character is performed in response to an operation input regarding the character, when the state of the character is a second state different from the first state.

6. The game device according to claim 1, wherein the communication interface is configured to perform communication wirelessly, and
wherein the controller is further configured to enable the communication interface to communicate with the external device, on a condition that information on an access point of the communication interface is set.

7. The game device according to claim 1, wherein the game device is configured to operate with power supplied from a battery,
wherein the game device further comprises a detector configured to detect a state of charge of the battery, and
wherein the controller is further configured to enable the communication interface to communicate with the external device on the condition that the battery is being charged.

8. The game device according to claim 1, further comprising:
a transition circuit configured to transition the game device to a suspended state in response to no operation input for a predetermined period of time, and
a return circuit configured to return the game device from the suspended state in response to an operation input being made or occurrence of a predetermined event,
wherein the controller is further configured to enable the communication interface to communicate with the external device on a condition that the game device is in the suspended state.

9. The game device according to claim 1, wherein when the current time falls within the predetermined time zone but another condition for enabling the communication interface to communicate with the external device is not fulfilled, the controller waits until the another condition is fulfilled.

10. The game device according to claim 1, wherein when the communication interface fails to establish communication connection with the external device, the controller causes the communication interface to retry the communication connection up to a predetermined number of times at a time interval.

11. The game device according to claim 10, wherein the time interval is set to be longer each time the number of times of retry increases.

12. The game device according to claim 1, wherein the communication interface is configured to perform at least one of transmission of information about the character, receipt of update data for a main body of the game device, receipt of new information, receipt of additional content data, and receipt of information about a character corresponding to another game device, during communication connection with the external device.

13. The game device according to claim 12, wherein the information about the character comprises at least one of information indicating an appearance of the character.

14. The game device according to claim 13, wherein the communication interface is configured to transmit the information about the character on a condition that a change has occurred in the appearance of the character in the game.

15. The game device according to claim 12, wherein when there is an update in the update data for the main body, the new information, and the additional content data, the communication interface receives the updated data or information.

16. A non-transitory computer-readable storage medium storing a program for causing a computer to function as the game device according to claim 1.
